(19) United States
(12) Patent Application Publication
(10) Pub. No.: US 2022/0350947 A1
(43) Pub. Date: Nov. 3, 2022

(54) Linearization Processing Method and Device for Nonlinear Model, And Storage Medium

(71) Applicant: Siemens Aktiengesellschaft, München (DE)

(72) Inventors: De Hui Wang, Beijing (CN); Ning Jiang, Beijing (CN); Tuo Zhang, Beijing (CN); Zhong Wei Tian, Beijing (CN)

(73) Assignee: Siemens Aktiengesellschaft, Beijing (DE)

(21) Appl. No.: 17/765,109

(22) PCT Filed: Sep. 30, 2019
(86) PCT No.: PCT/CN2019/109675

§ 371 Date: Mar. 30, 2022

(51) Int. Cl. G06F 30/27

(52) U.S. Cl. CPC G06F 30/27; G06F 2111/10

(57) ABSTRACT

Various embodiments of the teachings herein include a linearization processing method for nonlinear models. The method may include: for a nonlinear model of each piece of equipment, determining a value range of each input parameter of the model; dividing the value range of each input parameter into a plurality of subintervals based on a plurality of interpolation points; determining a plurality of input sample values in each subinterval in a balanced manner; traversing input sample value combinations of each input parameter of the model, and using the nonlinear model to obtain an output sample value combination corresponding to each input sample value combination; and using all the input sample value combinations and the corresponding output sample value combinations to generate a tensor table.

### CROSS-REFERENCE TO RELATED APPLICATIONS

This application is a U.S. National Stage Application of International Application No. PCT/CN2019/109675 filed Sep. 30, 2019, which designates the United States of America, the contents of which is hereby incorporated by reference in their entirety.

### TECHNICAL FIELD

The present disclosure relates to the industrial field. Various embodiments of the teachings herein include linearization processing methods and/or devices for nonlinear models, and a computer-readable storage medium in integrated energy systems.

### BACKGROUND

Distributed energy systems (DESs) are considered to be an effective way of addressing unstable consumption of renewable energies. DESs are being built all over the world and there is an increasing demand for models used for operational optimization and for overall scheduling of the systems in terms of energy production and utilization. Previous researchers have developed specific models for operational optimization that are only applicable to systems with specific energy sources and components. Thus, their models do not meet the requirements of the emerging integrated energy services in practical implementation.

Therefore, it is necessary to provide a universal integrated energy system, to make full use of renewable energies, fossil fuels, residual heat and pressure, new energies and other forms of resources, so that they can supplement each other, and to establish innovative business models through flexible operation of energy sources, the grid, loads and energy storage facilities, to achieve high-quality, high-efficiency, and the most economical integrated regional supply of power, heating, cooling, gas, etc. to various loads with good environmental effects by use of smart means, so that the requirements of random changes in the terminal loads are met. Integrated energy systems promote the consumption capacity of renewable energies and improve the overall utilization rate of energy.

However, in the process of implementing an integrated energy system as above, models need to be established for a lot of equipment, which usually incorporates many nonlinear physical processes (also called underlying processes), such as the processes related to flow and pressure in the compressor of a gas turbine, the process of converting mechanical energy into pressure energy, etc., and thus the models of such equipment are generally nonlinear models. A nonlinear model usually has a complicated modeling process, but as a result the accuracy is relatively high. However, if the nonlinear models are directly used to run the simulation of an integrated energy system, the relatively low running speed of nonlinear models may affect the real-time performance of simulating an entire integrated energy system.

### SUMMARY

In view of this, linearization processing methods for nonlinear models and linearization processing devices for nonlinear models and a computer-readable storage medium are proposed may be used for the linearization of some nonlinear models comprising nonlinear underlying processes, which are then used for the establishment of integrated energy systems. For example, some embodiments of the teachings herein include a linearization processing method for nonlinear models comprising: for a nonlinear model of each piece of equipment, determining a value range of each input parameter of the model; dividing the value range of each input parameter into a plurality of subintervals based on a plurality of interpolation points; determining a plurality of input sample values in each subinterval in a balanced manner; traversing input sample value combinations of each input parameter of the model, and using the nonlinear model to obtain an output sample value combination corresponding to each input sample value combination; and using all the input sample value combinations and the corresponding output sample value combinations to generate a tensor table.

In some embodiments, dividing the value range of each input parameter into a plurality of subintervals based on a plurality of interpolation points is based on a balancing criterion, dividing the value range of each input parameter into a plurality of subintervals based on a plurality of interpolation points.

In some embodiments, determining a plurality of input sample values in each subinterval in a balanced manner is determining a plurality of input sample values in each subinterval in a balanced manner based on a balancing criterion.

In some embodiments, during simulation, the tensor table is looked up according to a current value of each input parameter and the corresponding data found in the tensor table is used to perform interpolation processing to obtain a corresponding output value.

In some embodiments, the nonlinear model of each piece of equipment is obtained in the following modeling method: determining complete design point data for each target nonlinear underlying process of each type of equipment; establishing a descriptive formula of a nonlinear underlying process by use of the ratio of a similarity parameter supported by a similarity criterion to a similarity parameter based on the design point data, to obtain a universal model of the nonlinear underlying process, wherein the universal model comprises a variable parameter that changes nonlinearly as a parameter of an actual working condition changes; constructing a machine learning algorithm between the parameter of the actual working condition and the variable parameter, and establishing a correlation between the machine learning algorithm and the universal model; taking the universal models of all the target universal nonlinear processes of each type of equipment and the correlated machine learning algorithms as a universal model of a type of equipment; for each target nonlinear underlying process of one specific piece of equipment of a type of equipment, obtaining historical data of the parameter of the actual working condition and the variable parameter corresponding to a target nonlinear underlying process of the specific piece of equipment, and using the historical data to train the machine learning algorithm, to obtain a training model of the variable parameter of the target nonlinear underlying process; substituting the training model of the variable parameter of the target nonlinear underlying process into the universal model of the target nonlinear underlying process, to obtain a trained model of the target nonlinear underlying process of the specific piece of equipment; and taking the trained models of all the target nonlinear underlying processes of the specific piece of equipment as a trained model of the specific piece of equipment.

In some embodiments, the variable parameter has a preset default value.

In some embodiments, the equipment includes: gas turbines, heat pumps, internal combustion engines, steam turbines, waste heat boilers, absorption refrigerators, heating machines, multi-effect evaporators, water electrolyzers for hydrogen production, equipment for producing chemicals from hydrogen, reverse osmosis devices, fuel cells, and boilers; the target nonlinear underlying processes of each type of equipment include one or more of the following processes: a heat transfer process, a process of converting thermal energy to kinetic energy, a process of pipeline resistance, a process related to flow and pressure, a process of converting thermal energy to mechanical energy, a process of converting electrical energy to cold or heat energy, a rectification process, an evaporation process and a filtration process.

In some embodiments, a linearization processing device for nonlinear models comprises: a first processing module, used to, for a nonlinear model of each piece of equipment, determine a value range of each input parameter of the model; a second processing module, which divides the value range of each input parameter into a plurality of subintervals based on a plurality of interpolation points; a third processing module, used to determine a plurality of input sample values in each subinterval in a balanced manner; a fourth processing module, used to traverse input sample value combinations of each input parameter of the model, and use the nonlinear model to obtain an output sample value combination corresponding to each input sample value combination; and a fifth processing module, used to use all the input sample value combinations and the corresponding output sample value combinations to generate a tensor table.

In some embodiments, the second processing module divides the value range of each input parameter into a plurality of subintervals based on a plurality of interpolation points based on a balancing criterion.

In some embodiments, the third processing module determines a plurality of input sample values in each subinterval in a balanced manner based on a balancing criterion.

In some embodiments, the system further comprises: a sixth processing module, used to, during simulation, perform interpolation of the tensor table according to a current value of each input parameter, to obtain a corresponding output value.

In some embodiments, it further comprises: a first modeling module, used to determine complete design point data for each target nonlinear underlying process of each type of equipment; establish a descriptive formula of a nonlinear underlying process by use of the ratio of a similarity parameter supported by a similarity criterion to a similarity parameter based on the design point data, to obtain a universal model of the nonlinear underlying process, wherein the universal model comprises a variable parameter that changes nonlinearly as a parameter of an actual working condition changes; construct a machine learning algorithm between the parameter of the actual working condition and the variable parameter, and establish a correlation between the machine learning algorithm and the universal model; and take the universal models of all the target universal nonlinear processes of each type of equipment and the correlated machine learning algorithms as a universal model of a type of equipment; and a second modeling module, used to, for each target nonlinear underlying process of one specific piece of equipment of a type of equipment, obtain historical data of the parameter of the actual working condition and the variable parameter corresponding to a target nonlinear underlying process of the specific piece of equipment, and use the historical data to train the machine learning algorithm, to obtain a training model of the variable parameter of the target nonlinear underlying process; substitute the training model of the variable parameter of the target nonlinear underlying process into the universal model of the target nonlinear underlying process, to obtain a trained model of the target nonlinear underlying process of the specific piece of equipment; and take the trained models of all the target nonlinear underlying processes of the specific piece of equipment as a trained model of the specific piece of equipment.

In some embodiments, a linearization processing device for nonlinear models comprises: at least one memory and at least one processor, wherein: the at least one memory is used to store a computer program; the at least one processor is used to call the computer program stored in the at least one memory to execute the linearization processing method for nonlinear models described in any of the above implementations.

In some embodiments, a computer-readable storage medium has a computer program stored thereon; the computer program can be executed by a processor and implement the linearization processing method described in any of the above implementations.

### BRIEF DESCRIPTION OF THE DRAWINGS

Example embodiments of the teachings of the present disclosure are described in detail below with reference to the drawings, so that those skilled in the art will better understand the above and other features and advantages of the teachings. In the drawings:

FIG. 1 is an exemplary flowchart of a linearization processing method for nonlinear models incorporating teachings of the present disclosure;

FIG. 2 is an exemplary flowchart of a modeling method for nonlinear models incorporating teachings of the present disclosure;

FIG. 3 is an exemplary structural diagram of a linearization processing device for nonlinear models incorporating teachings of the present disclosure;

FIG. 4 is an exemplary flowchart of another linearization processing device for nonlinear models incorporating teachings of the present disclosure;

FIG. 5 is an exemplary flowchart of another linearization processing device for nonlinear models incorporating teachings of the present disclosure.

In the drawings, the following reference numerals are used:

| Numeral | Meaning |
|---|---|
| 101-105, 201-207 | Steps |
| 301 | First processing module |
| 302 | Second processing module |
| 303 | Third processing module |
| 304 | Fourth processing module |
| 305 | Fifth processing module |
| 306 | Sixth processing module |
| 307 | First modeling module |
| 308 | Second modeling module |
| 51 | Memory |
| 52 | Processor |
| 53 | Bus |

### DETAILED DESCRIPTION

In some embodiments, a segmented linearization technique is used to process nonlinear models to obtain a tensor table. In addition, in simulation application, interpolation is performed based on the tensor table, to obtain the required simulation data. A linearized equipment model runs faster and can meet the real-time requirement in simulation.

In addition, in the equipment modeling, a universal model of a nonlinear underlying process may be obtained by establishing a descriptive formula of the nonlinear underlying process by use of the ratio of a similarity parameter supported by a similarity criterion to a similarity parameter based on design point data for each target nonlinear underlying process of each type of equipment, and the model is applicable to one type of equipment as a universal model. Moreover, the universal model comprises a variable parameter that changes nonlinearly as a parameter of the actual working condition changes, and the variable parameter can be obtained by machine learning through establishing a machine learning algorithm between the parameter of the actual working condition and the variable parameter, so that the universal model is capable of self-learning.

Furthermore, for one specific piece of equipment of the type of equipment, historical data of the parameter of the actual working condition and the variable parameter corresponding to a target nonlinear underlying process of the specific piece of equipment can be obtained for each target nonlinear underlying process, and the historical data is used to train the machine learning algorithm, to obtain a training model of the variable parameter of the target nonlinear underlying process; the training model of the variable parameter of the target nonlinear underlying process is substituted into the universal model of the target nonlinear underlying process, to obtain a trained model of the target nonlinear underlying process of the specific piece of equipment, i.e., an instantiated model conforming to the characteristics of the specific piece of equipment.

In addition, by setting the default value of the variable parameter in advance, it is possible to make the nonlinear model available where site conditions do not permit training the variable parameter, for example, when there is not enough historical data, etc.

Lastly, the modeling method in the embodiments of the present invention may be applied to various nonlinear processes of different types of equipment, with easy implementation and high accuracy. The following example embodiments will further illustrate the teachings of the present disclosure in detail in order to clarify its purpose, technical solution and advantages.

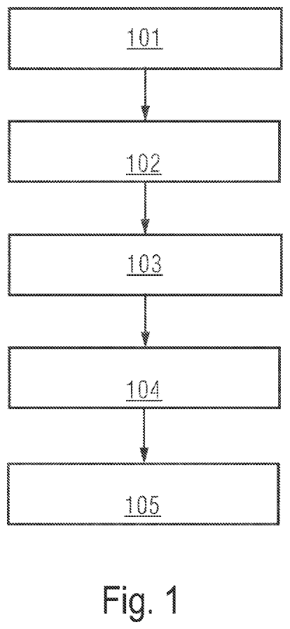

FIG. 1 is an exemplary flowchart of a linearization processing method for nonlinear models incorporating teachings of the present disclosure. As shown in FIG. 1, the method may comprise:

Step 101, for a nonlinear model of each piece of equipment, determining a value range of each input parameter of the model. For example, the effective power range is 50% to 110% of the rated power, and there is also the range of change in the local ambient temperature, the range of change in the ambient pressure, etc.

Step 102, dividing the value range of each input parameter into a plurality of subintervals based on a plurality of interpolation points. In this step, the value range of each input parameter may be divided into a plurality of subintervals based on a plurality of interpolation points based on a balancing criterion. Specifically, for the setting of interpolation points, more interpolation points may be set in regions with drastic nonlinear changes, while fewer interpolation points may be set in regions with slow nonlinear changes. For example, 40 points are interpolated for the power range, 20 points are interpolated for the ambient temperature, 5 points are interpolated for the ambient pressure, etc.

Step 103, determining a plurality of input sample values in each subinterval in a balanced manner. In this step, a plurality of input sample values in each subinterval may be determined in a balanced manner based on a balancing criterion. For example, equal division may be used for power, ambient temperature, etc. in the real domain.

Step 104, traversing input sample value combinations of each input parameter of the model, and using the nonlinear model to obtain an output sample value combination corresponding to each input sample value combination. For example, there is one set of outputs corresponding to each set of input sample values obtained by traversing, for example, efficiency output, or fuel consumption or emission output, operation cost output, etc.

Step 105, using all the input sample value combinations and the corresponding output sample value combinations to generate a tensor table. For example, when the values of the abovementioned three dimensions of temperature, pressure and power are known, the value of efficiency can be obtained by interpolation through looking up the tensor table. In some embodiments, during simulation by use of the model of the equipment, the tensor table is looked up according to a current value of each input parameter, and the corresponding value found in the tensor table is used to perform interpolation processing to obtain a corresponding output value. In the process, the current value of each input parameter may be a real value or an assumed value.

For example, there may be one or more tables for one piece of equipment, for example, one table where temperature, pressure and power correspond to efficiency, one table where temperature, pressure and power correspond to emission, or correspond to any other desired parameter. In the process, the interpolation algorithm may be selected based on actual conditions. For example, linear interpolation, nonlinear interpolation, etc. may be selected. In one example, linear interpolation may be used for points close to each other, while nonlinear interpolation may be used for points far away from each other.

The values of other output variables corresponding to the required temperature, pressure and performance can be obtained by spline interpolation of the three dimensions of temperature, pressure and power. This general method uses a general program, and all kinds of specific models, for example, the models of heat pumps, internal combustion engines, heat exchangers, etc. can be processed by this segment of code as the tool.

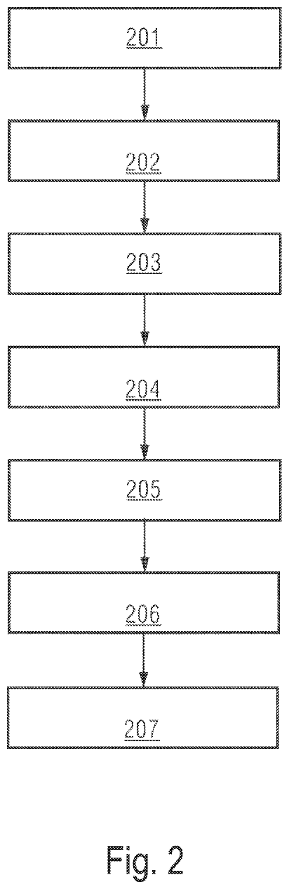

FIG. 2 is an exemplary flowchart of a modeling method for nonlinear models incorporating teachings of the present disclosure. As shown in FIG. 2, the method may comprise:

Step 201, determining complete design point data for each target nonlinear underlying process of each type of equipment. In this step, an underlying process may sometimes be referred to as a physical process, for example, a heat transfer process, a process for converting electrical energy, and a process related to flow and pressure as mentioned previously. For each device, the underlying processes of interest can be determined, i.e., the underlying processes that need to be modeled. These underlying processes that need to be modeled are referred to as target underlying processes, and those nonlinear target underlying processes can be referred to as target nonlinear underlying processes.

For example, for gas turbines, the target nonlinear underlying processes may include: a process related to flow and pressure in the expansion turbine, a process of energy conversion between thermal energy and mechanical energy, etc.; for heat pumps, the target nonlinear underlying processes may include: a heat transfer process, a process of converting electrical energy to thermal energy, a chemical process of separate solution substances by use of high-temperature thermal energy, an electrochemical process, a pipeline resistance process, a process related to flow and pressure, etc. In addition, for equipment such as gas turbines, heat pumps, internal combustion engines, steam turbines, waste heat boilers, absorption refrigerators, heating machines, multi-effect evaporators, water electrolyzers for hydrogen production, equipment for producing chemicals from hydrogen, reverse osmosis devices, fuel cells, boilers, etc., the target nonlinear underlying processes of each piece of equipment may include one or more of the following: a process related to flow and pressure, a process of converting thermal energy to mechanical energy, a process of converting electrical energy to cold or heat energy, a process of pipeline resistance, a heat transfer process, a rectification process, an evaporation process, a filtration process, a chemical reaction process, an electrochemical process, etc.

For each nonlinear underlying process, the complete design point data can be restored according to the published basic design parameters and the common design point information provided to the user by the manufacturer. For example, for a general model of a process related to flow and pressure, its design point data may comprise the pressure ratio, air flow, etc., and, based on these design point data, relevant design parameters not available to users can be derived, such as the efficiency, inlet resistance, air extraction volume, etc.

Step 202, establishing a descriptive formula of the nonlinear underlying process by use of the ratio of a similarity parameter supported by a similarity criterion to a similarity parameter based on design point data, to obtain a universal model of the nonlinear underlying process; wherein the universal model comprises a variable parameter that changes as a parameter of an actual working condition changes. In this step, a parameter of an actual working condition refers to a parameter of a specific piece of equipment that changes as the parameters of the actual working condition change. For example, it may be a dimension that changes as mechanical wear occurs after a long time of use, or the temperature that changes as the season changes, or relevant parameters that change as the work condition varies. The variable parameter may have a preset default value.

Since there may be different models for each type of equipment, for example, there may be compressors with different powers such as 5M, 50M, 500M, etc., in order to establish a universal model of compressors, it is necessary to adopt a similarity criterion to support a similarity parameter to replace a specific parameter value. For example, still taking the universal model of the above process related to flow and pressure as an example, the similarity parameters supported by the similarity criteria of flow, pressure and power are used instead of the specific parameters. For example, the similarity criteria of flow may be expressed by formula (1) below:

$$\frac{\frac{G 1 \sqrt{T 1}}{P 1}}{\frac{G 0 \sqrt{T 0}}{P 0}} \qquad ( 1 )$$

where G1 is the flow, T1 is the temperature, P1 is the pressure, G0 is the flow of the corresponding deign point, T0 is the temperature of the corresponding design point, and P0 is the pressure of the corresponding design point.

Accordingly, the universal model of a process related to flow and pressure may be expressed by formula (2) below:

$$\frac{\frac{G 1 \sqrt{T 1}}{P 1}}{\frac{G 0 \sqrt{T 0}}{P 0}} = f ( a ⨯ IGV angle , b ⨯ similarity rotation speed ratio ) \qquad ( 2 )$$

where f( ) is a function, coefficients a and b are variable parameters that change as the parameters of the actual working condition change, and in practical application, a default value may be set for the variable parameters a and b. IGV is the angle of the inlet adjustable guide vane.

Step 203, constructing a machine learning algorithm between the parameter of the actual working condition and the variable parameter. In this step, a machine learning algorithm between the parameter of the actual working condition and the variable parameter may be constructed based on an intelligent neural network or a method supporting big data analysis for machine learning such as vector machines, etc.

Step 204, taking the universal models of all the target nonlinear underlying processes of each type of equipment and the correlated machine learning algorithms as a universal model of the type of equipment. It can be seen that a nonlinear universal model can be established for each type of equipment through the above process. An integrated energy system platform can be constructed based on these universal models.

In practical application, after purchasing the integrated energy system platform, the user needs to build their own integrated energy system. At this point, each universal model needs to be associated with specific equipment on site, and thus the universal models need to be instantiated. Accordingly, the method may further comprise:

Step 205, for each target nonlinear underlying process of one specific piece of equipment of the type of equipment, obtaining historical data of the parameter of the actual working condition and the variable parameter corresponding to the target nonlinear underlying process of the specific piece of equipment, and using the historical data to train the corresponding machine learning algorithm, to obtain a training model of the variable parameter of the target nonlinear underlying process. In this step, during specific training, a set of historical data of the parameter of the actual working condition is used as input sample values, the historical data of the variable parameter corresponding to the set of historical data of the parameter of the actual working condition is used as output sample values, and a large number of input sample values and the corresponding output sample values are used to train the machine learning algorithm, to obtain a self-learning model of the variable parameter, also referred to as a training model.

For example, still taking the abovementioned process related to flow and pressure as an example, the historical data of the relevant parameters of the actual working condition of a gas turbine on site and the historical data of the corresponding variable parameters can be obtained, to obtain the input and output sample sets, and a trained model of the variable parameters a and b can be obtained through training.

Step 206, substituting the training model of the variable parameter of the target nonlinear underlying process into the universal model of the target nonlinear underlying process, to obtain a trained model of the target nonlinear underlying process of the specific piece of equipment. The trained model is a self-learning model capable of learning. In this step, according to the correlation between the machine learning algorithm and the universal model, the training model of the variable parameter of the target nonlinear underlying process can be substituted into the universal model of the target nonlinear underlying process.

For example, still taking the abovementioned process related to flow and pressure as an example, by inputting the current training model of the variable parameters a and b into formula (2) above, the universal model of the process related to flow and pressure of the compressor of the gas turbine on site can be obtained.

Step 207, taking the trained models of all the target nonlinear underlying processes of the specific piece of equipment as a universal model of the specific piece of equipment. In actual use, the input parameters of the trained model may include the input parameters required for the trained models of all the target nonlinear underlying processes.

The linearization processing method for nonlinear models and one modeling method in the embodiments of the present invention are described in detail above, and the linearization processing device for nonlinear models and one modeling device in the embodiments of the present invention will be described in detail below. The devices in the embodiments described can be used to implement the methods. Details not disclosed in the device embodiments can be found in the corresponding description of the method embodiments, and will not be detailed here.

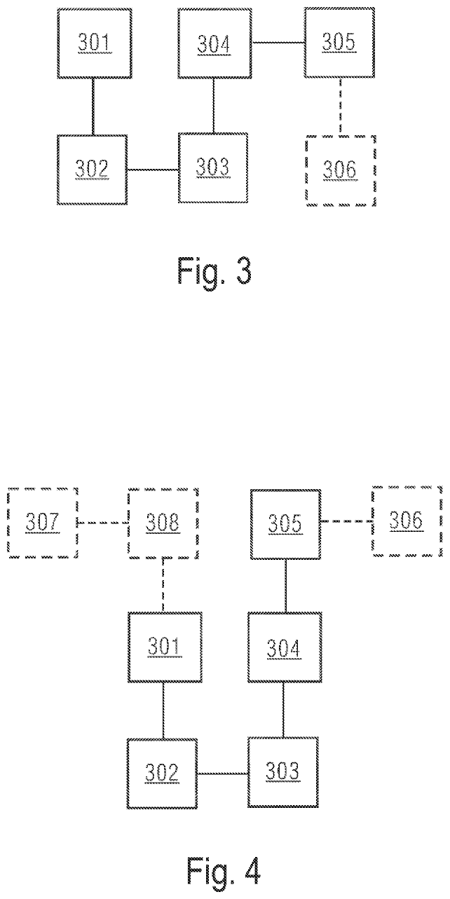

FIG. 3 is an exemplary structural diagram of a linearization processing device for nonlinear models incorporating teachings of the present disclosure. As shown in FIG. 3, the device may comprise: a first processing module 301, a second processing module 302, a third processing module 303, a fourth processing module 304 and a fifth processing module 305.

The first processing module 301 is used to determine a value range of each input parameter of a nonlinear model of each piece of equipment.

The second processing module 302 divides the value range of each input parameter into a plurality of subintervals based on a plurality of interpolation points. In one specific implementation, the second processing module 302 may divide the value range of each input parameter into a plurality of subintervals based on a plurality of interpolation points based on a balancing criterion.

The third processing module 303 is used to determine a plurality of input sample values in each subinterval in a balanced manner. In one specific implementation, the third processing module 303 determines a plurality of input sample values in each subinterval in a balanced manner based on a balancing criterion.

The fourth processing module 304 is used to traverse input sample value combinations of each input parameter of the model, and use the nonlinear model to obtain an output sample value combination corresponding to each input sample value combination.

The fifth processing module 305 is used to use all the input sample value combinations and the corresponding output sample value combinations to generate a tensor table.

In some embodiments, the linearization processing device for nonlinear models may further comprise, as shown by the part marked by dotted lines in FIG. 3: a sixth processing module 306, used to, during simulation, perform interpolation of the tensor table according to a current value of each input parameter, to obtain a corresponding output value.

FIG. 4 is an exemplary flowchart of another linearization processing device for nonlinear models incorporating teachings of the present disclosure. As shown in FIG. 4, based on the device shown in FIG. 3, the device may further comprise: a first modeling module 307 and a second modeling module 308.

Between them, the first modeling module 307 is used to determine complete design point data for each target nonlinear underlying process of each type of equipment; establish a descriptive formula of a nonlinear underlying process by use of the ratio of a similarity parameter supported by a similarity criterion to a similarity parameter based on the design point data, to obtain a universal model of the nonlinear underlying process, wherein the universal model comprises a variable parameter that changes nonlinearly as a parameter of an actual working condition changes; construct a machine learning algorithm between the parameter of the actual working condition and the variable parameter, and establish a correlation between the machine learning algorithm and the universal model; and take the universal models of all the target universal nonlinear processes of each type of equipment and the correlated machine learning algorithms as a universal model of a type of equipment.

The second modeling module 308 is used to, for each target nonlinear underlying process of one specific piece of equipment of the type of equipment, obtain historical data of the parameter of the actual working condition and the variable parameter corresponding to the target nonlinear underlying process of the specific piece of equipment, and use the historical data to train the machine learning algorithm, to obtain a training model of the variable parameter of the target nonlinear underlying process; substitute the training model of the variable parameter of the target nonlinear underlying process into the universal model of the target nonlinear underlying process, to obtain a trained model of the target nonlinear underlying process of the specific piece of equipment; and take the trained models of all the target nonlinear underlying processes of the specific piece of equipment as a trained model of the specific piece of equipment.

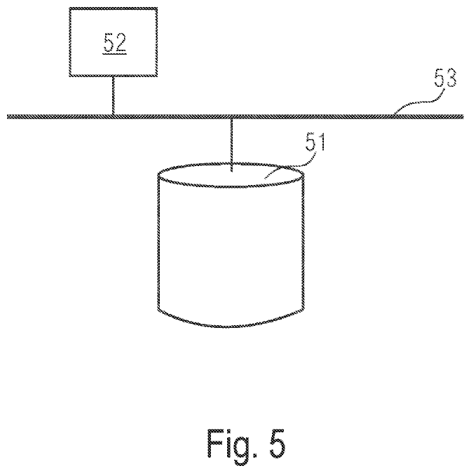

FIG. 5 is a schematic structural diagram of another linearization processing device for nonlinear models incorporating teachings of the present disclosure. As shown in FIG. 5, the system may comprise: at least one memory 51 and at least one processor 52. In addition, some other components, for example, communication ports, etc., may also be comprised. These components communicate via a bus 53.

Specifically, the at least one memory 51 is used to store a computer program. In some embodiments, the computer program may comprise each of the modules of the linearization processing device for nonlinear models as shown in FIG. 3 or FIG. 4. In addition, the at least one memory 51 may also store an operating system, etc. The operating system may be but is not limited to: an Android operating system, a Symbian operating system, a Windows operating system, a Linux operating system, etc.

The at least one processor 52 is used to call the computer program stored in the at least one memory 51 to execute the linearization processing method for nonlinear models described in the embodiments of the present invention. The processor 52 may be a CPU, a processing unit/module, an ASIC, a logic module, a programmable gate array, etc. It can receive and send data through the communication ports.

It should be noted that not all steps and modules in the above flowcharts and structural diagrams are necessary, and some steps or modules can be ignored based on actual needs. The sequence of execution of the steps is not fixed, and can be adjusted as needed. A functional division of the modules is used only to facilitate the description. In some embodiments, a module may be implemented by multiple modules, and the functions of multiple modules may be implemented by a single module. These modules may be located in a single device or in different devices.

In some embodiments, the hardware modules in each embodiment above may be implemented mechanically or electronically. For example, a hardware module may comprise specially designed permanent circuits or logic devices (for example, dedicated processors, such as FPGA or ASIC) to complete specific operations. A hardware module may also comprise programmable logic devices or circuits temporarily configured by software (for example, general-purpose processors or other programmable processors) for performing specific operations. Whether to specifically use mechanical methods or dedicated permanent circuits or temporarily configured circuits (such as software configuration) to implement hardware modules may be determined according to cost and schedule considerations.

In some embodiments, a computer-readable storage medium has a computer program stored thereon, which can be executed by a processor and implement the linearization processing method for nonlinear models described in the embodiments of the present invention. Specifically, a system or device equipped with a storage medium may store software program code for implementing the functions of any of the above implementations is stored on the storage medium, so that a computer (or CPU or MPU) of the system or device reads and executes the program code stored in the storage medium. In addition, the operating system operating on the computer may also be used to perform part or all of the actual operations through instructions based on the program code. It is also possible to write the program code read from the storage medium to the memory provided in an expansion board inserted into the computer or to the memory provided in an expansion unit connected to the computer, and then the program code-based instructions cause the CPU, etc. mounted on the expansion board or the expansion unit to perform part or all of the actual operations, so as to implement the functions of any of the above embodiments. Implementations of the storage media used to provide the program code include floppy disks, hard disks, magneto-optical disks, optical disks (such as CD-ROM, CD-R, CD-RW, DVD-ROM, DVD-RAM, DVD-RW, DVD+RW), magnetic tapes, non-volatile memory cards and ROMs. Optionally, the program code may be downloaded from a server computer via a communication network.

It can be seen from the above description that a segmented linearization technique may be used to process nonlinear models to obtain a tensor table. In addition, in simulation application, interpolation may be performed based on the tensor table, to obtain the required simulation data. A linearized equipment model runs faster and can meet the real-time requirement in simulation.

In the equipment modeling, a universal model of a nonlinear underlying process may be obtained by establishing a descriptive formula of the nonlinear underlying process by use of the ratio of a similarity parameter supported by a similarity criterion to a similarity parameter based on design point data for each target nonlinear underlying process of each type of equipment, and the model is applicable to one type of equipment as a universal model. Moreover, the universal model comprises a variable parameter that changes nonlinearly as a parameter of the actual working condition changes, and the variable parameter can be obtained by machine learning through establishing a machine learning algorithm between the parameter of the actual working condition and the variable parameter, so that the universal model is capable of self-learning.

Furthermore, for one specific piece of equipment of the type of equipment, historical data of the parameter of the actual working condition and the variable parameter corresponding to a target nonlinear underlying process of the specific piece of equipment can be obtained for each target nonlinear underlying process, and the historical data may be used to train the machine learning algorithm, to obtain a training model of the variable parameter of the target nonlinear underlying process; the training model of the variable parameter of the target nonlinear underlying process is substituted into the universal model of the target nonlinear underlying process, to obtain a trained model of the target nonlinear underlying process of the specific piece of equipment, i.e., an instantiated model conforming to the characteristics of the specific piece of equipment.

In addition, by setting the default value of the variable parameter in advance, it is possible to make the nonlinear model available where site conditions do not permit training the variable parameter, for example, when there is not enough historical data, etc.

Lastly, the modeling method in the embodiments of the present invention may be applied to various nonlinear processes of different types of equipment, with easy implementation and high accuracy.

The above are only example embodiments of the present disclosure, and are not intended to limit the scope thereof. Any modification, equivalent replacement and improvement made without departing from the motivation and principle of the present disclosure shall be included in its scope.

What is claimed is:

1. A linearization processing method for nonlinear models, the method comprising:
for a nonlinear model of each piece of equipment, determining a value range of each input parameter of the model;
dividing the value range of each input parameter into a plurality of subintervals based on a plurality of interpolation points;
determining a plurality of input sample values in each subinterval in a balanced manner;
traversing input sample value combinations of each input parameter of the model, and using the nonlinear model to obtain an output sample value combination corresponding to each input sample value combination; and
using all the input sample value combinations and the corresponding output sample value combinations to generate a tensor table.

2. The linearization processing method for nonlinear models as claimed in claim 1, wherein dividing the value range of each input parameter into a plurality of subintervals based on a plurality of interpolation points is based on a balancing criterion dividing the value range of each input parameter into a plurality of subintervals based on a plurality of interpolation points.

3. The linearization processing method for nonlinear models as claimed in claim 1, wherein determining a plurality of input sample values in each subinterval in a balanced manner comprises determining a plurality of input sample values in each subinterval in a balanced manner based on a balancing criterion.

4. The linearization processing method for nonlinear models as claimed in claim 1, wherein,
during simulation, the tensor table is looked up according to a current value of each input parameter, and the corresponding data found in the tensor table is used to perform interpolation processing to obtain a corresponding output value.

5. The linearization processing method for nonlinear models as claimed in claim 1, wherein a nonlinear model of each piece of equipment is obtained by:
determining complete design point data for each target nonlinear underlying process of each type of equipment;
establishing a descriptive formula of the nonlinear underlying process by use of the ratio of a similarity parameter supported by a similarity criterion to a similarity parameter based on design point data, to obtain a universal model of the nonlinear underlying process;
wherein the universal model comprises a variable parameter that changes as a parameter of an actual working condition changes;
constructing a machine learning algorithm between the parameter of the actual working condition and the variable parameter, and establishing a correlation between the machine learning algorithm and the universal model;
taking the universal models of all the target nonlinear underlying processes of each type of equipment and the correlated machine learning algorithms as a universal model of the type of equipment;
for each target nonlinear underlying process of one specific piece of equipment of the type of equipment, obtaining historical data of the parameter of the actual working condition and the variable parameter corresponding to the target nonlinear underlying process of the specific piece of equipment, and using the historical data to train the machine learning algorithm, to obtain a training model of the variable parameter of the target nonlinear underlying process;
substituting the training model of the variable parameter of the target nonlinear underlying process into the universal model of the target nonlinear underlying process, to obtain a trained model of the target nonlinear underlying process of the specific piece of equipment; and
taking the trained models of all the target nonlinear underlying processes of the specific piece of equipment as a universal model of the specific piece of equipment.

6. The linearization processing method for nonlinear models as claimed in claim 5, wherein the variable parameter has a preset default value.

7. The linearization processing method for nonlinear models as claimed in claim 5, wherein the equipment includes: gas turbines, heat pumps, internal combustion engines, steam turbines, waste heat boilers, absorption refrigerators, heating machines, multi-effect evaporators, water electrolyzers for hydrogen production, equipment for producing chemicals from hydrogen, reverse osmosis devices, fuel cells, and boilers;
the target nonlinear underlying processes of each type of equipment include one or more of the following processes: a heat transfer process, a process of converting thermal energy to kinetic energy, a process of pipeline resistance, a process related to flow and pressure, a process of converting thermal energy to mechanical energy, a process of converting electrical energy to cold or heat energy, a rectification process, an evaporation process, and a filtration process.

8. A linearization processing device for nonlinear models, the device comprising:
a first processing module used to determine a value range of each input parameter of a nonlinear model of each piece of equipment;
a second processing module dividing the value range of each input parameter into a plurality of subintervals based on a plurality of interpolation points;
a third processing module determining a plurality of input sample values in each subinterval in a balanced manner;
a fourth processing module traversing input sample value combinations of each input parameter of the model and using the nonlinear model to obtain an output sample value combination corresponding to each input sample value combination; and
a fifth processing module using all the input sample value combinations and the corresponding output sample value combinations to generate a tensor table.

9. The linearization processing device for nonlinear models as claimed in claim 8, wherein the second processing module divides the value range of each input parameter into a plurality of subintervals based on a plurality of interpolation points based on a balancing criterion.

10. The linearization processing device for nonlinear models as claimed in claim 8, wherein the third processing module determines a plurality of input sample values in each subinterval in a balanced manner based on a balancing criterion.

11. The linearization processing device for nonlinear models as claimed in claim 8, further comprising
a sixth processing module, during simulation, performing interpolation of the tensor table according to a current value of each input parameter to obtain a corresponding output value.

12. The linearization processing device for nonlinear models as claimed in claim 8, further comprising:
a first modeling module programmed to:
determine complete design point data for each target nonlinear underlying process of each type of equipment;
establish a descriptive formula of a nonlinear underlying process by use of the ratio of a similarity parameter supported by a similarity criterion to a similarity parameter based on the design point data, to obtain a universal model of the nonlinear underlying process, wherein the universal model comprises a variable parameter that changes nonlinearly as a parameter of an actual working condition changes;
construct a machine learning algorithm between the parameter of the actual working condition and the variable parameter, and establish a correlation between the machine learning algorithm and the universal model; and
take the universal models of all the target universal nonlinear processes of each type of equipment and the correlated machine learning algorithms as a universal model of a type of equipment; and
a second modeling module programmed to:
for each target nonlinear underlying process of one specific piece of equipment of the type of equipment, obtain historical data of the parameter of the actual working condition and the variable parameter corresponding to the target nonlinear underlying process of the specific piece of equipment, and use the historical data to train the machine learning algorithm to obtain a training model of the variable parameter of the target nonlinear underlying process;
substitute the training model of the variable parameter of the target nonlinear underlying process into the universal model of the target nonlinear underlying process, to obtain a trained model of the target nonlinear underlying process of the specific piece of equipment; and
take the trained models of all the target nonlinear underlying processes of the specific piece of equipment as a trained model of the specific piece of equipment.

13. A linearization processing device for nonlinear models, the device comprising:
a memory; and
a processor;
wherein
the memory stores a computer program; and
the processor calls the computer program stored in the memory to execute a linearization processing method for nonlinear models as claimed in any of claim 1.

14. A computer-readable storage medium storing a computer program, wherein the computer program can be executed by a processor and implement the linearization processing method for nonlinear models as claimed in claim 1.
